(19) United States
(12) Patent Application Publication
(10) Pub. No.: US 2022/0327365 A1
(43) Pub. Date: Oct. 13, 2022

(54) INFORMATION PROCESSING APPARATUS, INFORMATION PROCESSING METHOD, AND STORAGE MEDIUM

(71) Applicant: Nozomu Kubota, Tokyo (JP)

(72) Inventor: Nozomu Kubota, Tokyo (JP)

(21) Appl. No.: 17/718,141

(22) Filed: Apr. 11, 2022

(30) Foreign Application Priority Data
Apr. 12, 2021 (JP) 2021-067136

(51) Int. Cl. G06N 3/063; G06N 3/08; G06K 9/62

(52) U.S. Cl. CPC G06N 3/063; G06N 3/084; G06K 9/6256

(57) ABSTRACT

To cause a more appropriate function to be applied to a hidden layer in a neural network.

An information processing apparatus including a memory and one or a plurality of processors, wherein the memory stores: a learning model using a neural network; each function usable in a hidden layer of the neural network; and a first function that is produced by weighting each of the functions, and the one or a plurality of processors: acquire prescribed learning data; apply the first function commonly to a prescribed node group in a hidden layer of the learning model; perform learning by inputting the acquired prescribed learning data to the learning model in which the first function has been applied to the hidden layer; when learning the learning model, update a parameter of a neural network of the learning model by error back propagation, based on a supervisor label of the prescribed learning data; adjust each weight of the first function when the parameter of the neural network is updated; and produce, after the learning model is learned, a second function in which each of the adjusted weights is set to the first function.

### BACKGROUND

### Field

The present invention relates to an information processing apparatus, an information processing method, and a storage medium.

### Description of Related Art

In recent years, there have been attempts to address various problems by applying so-called artificial intelligence. For example, Patent Publication JP-A-2019-220063 discloses a model selecting device directed to solve problems in various real events.

### SUMMARY

However, as things stand, as a function used in a hidden layer (intermediate layer) in a learning model using a neural network, an existing function is selected based on knowledge empirically obtained by a developer or the like. For example, as an activation function, a ReLU function or a sigmoid function is often selected. However, in many cases, the reason for the selection is not a theoretical reason, i.e., these functions are used in many studies, but, rather, an intuitive reason. Therefore, it is not always the case that, with respect to input data, an activation function adapted to the input data is selected. In addition to an activation function, similar problems occur with respect to a normalization function, a denoising operation function, a regularization function, a smoothing function, and the like which are used in a hidden layer.

In consideration thereof, an object of the present invention is to provide an information processing apparatus, an information processing method, and a program that enable a more appropriate function to be applied to a hidden layer in a neural network.

An information processing apparatus according to one aspect of the present invention is an information processing apparatus including a memory and one or a plurality of processors, wherein

the memory stores:

a learning model using a neural network;

each function usable in a hidden layer of the neural network; and

a first function that is produced by weighting each of the functions, and

the one or a plurality of processors configured to:

acquire prescribed learning data;

apply the first function commonly to a prescribed node group in a hidden layer of the learning model;

perform learning by inputting the acquired prescribed learning data to the learning model in which the first function has been applied to the hidden layer;

when learning the learning model, update a parameter of a neural network of the learning model by error back propagation, based on a supervisor label of the prescribed learning data;

adjust each weight of the first function when the parameter of the neural network is updated; and

produce, after the learning model is learned, a second function in which each of the adjusted weights is set to the first function.

According to the present invention, an information processing apparatus, an information processing method, and a storage medium that enable a more appropriate function to be applied to a hidden layer in a neural network can be provided.

### BRIEF DESCRIPTION OF DRAWINGS

FIG. 1 is a diagram showing an example of a physical configuration of an information processing apparatus according to an embodiment;

FIG. 2 is a diagram showing an example of processing blocks of the information processing apparatus according to the embodiment;

FIG. 3 is a diagram showing an example of a learning model according to the embodiment;

FIG. 4 is a diagram for describing a function to be applied to a hidden layer according to the embodiment;

FIG. 5 is a diagram showing an example of a function library according to the embodiment;

FIG. 6 is a diagram showing an example of types of data and correspondence data of a second function according to the embodiment;

FIG. 7 is a flowchart showing an example of processing in a learning phase according to the embodiment; and

FIG. 8 is a flowchart showing an example of processing in an inference phase according to the embodiment.

### DETAILED DESCRIPTION

An embodiment of the present invention will be described in conjunction with the accompanying drawings. Note that elements designated by same reference characters in the drawings have identical or substantially identical features.

### Embodiment

### Processing Configuration

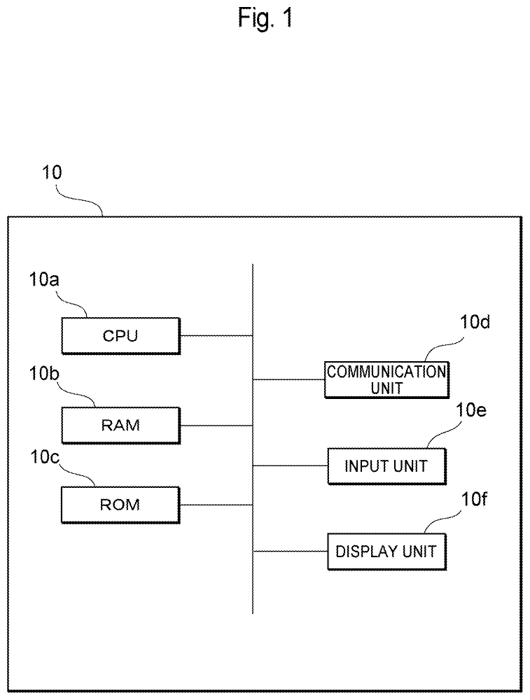

FIG. 1 is a diagram showing an example of a physical configuration of an information processing apparatus 10 according to an embodiment. The information processing apparatus 10 includes one or a plurality of CPUs (Central Processing Unit) 10a corresponding to a computing unit, a RAM (Random Access Memory) 10b corresponding to a storage unit, a ROM (Read only Memory) 10c corresponding to the storage unit, a communication unit 10d, an input unit 10e, and a display unit 10f. These components are connected with one another through a bus so that data can be transmitted and received among one another.

In the present embodiment, the information processing apparatus 10 including one computer will be described. However, the information processing apparatus 10 may be implemented as a combination of a plurality of computers or a plurality of computing units. The configuration shown in FIG. 1 is an example only, and the information processing apparatus 10 may have other components or may not have some of these components.

The CPU 10a is a control unit which controls execution of programs stored in the RAM 10b or the ROM 10c and computes and processes data. The CPU 10a is a computing unit which executes a program (a learning program) that performs learning using a learning model that enables a more appropriate function to be applied to a hidden layer. The CPU 10a receives various kinds of data from the input unit 10e and the communication unit 10d, displays a computation result of the data on the display unit 10f or stores the data in the RAM 10b.

The RAM 10b is a part of the storage unit in which data can be rewritten and may include a semiconductor storage device. The RAM 10b may store a program to be executed by the CPU 10a and data such as function data related to a function to be applied to a hidden layer, a learning model having a hidden layer to which the function is to be applied, and data indicating a correspondence relationship between a category of data and the learning model. These kinds of data are exemplary, and the RAM 10b may store data other than the above or may not store part of the above data.

The ROM 10c is a part of the storage unit from which data can be read out and may include a semiconductor storage device. The ROM 10c may store learning programs or data that is not rewritten.

The communication unit 10d is an interface which connects the information processing apparatus 10 to other devices. The communication unit 10d may be connected to a communication network such as the Internet.

The input unit 10e receives data input by a user and may include a keyboard and a touch panel.

The display unit 10f is configured to visually display a computation result by the CPU 10a and may include an LCD (Liquid Crystal Display). Displaying the computation result on the display unit 10f may contribute to XAI (eXplainable AI). The display unit 10f may display, for example, a learning result and function data.

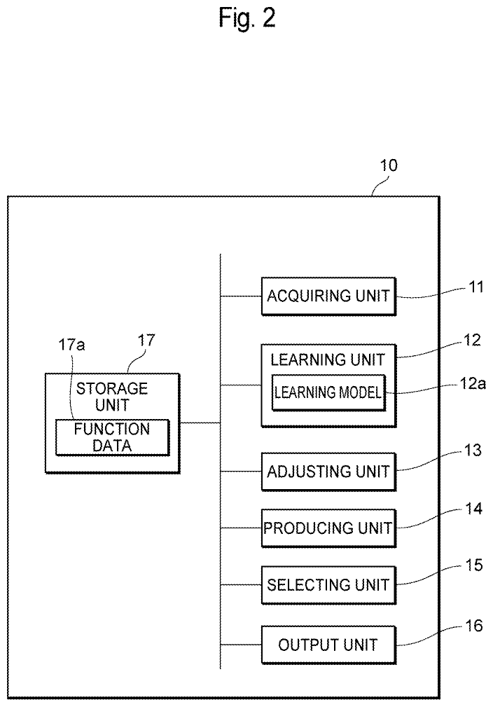

The learning program may be stored in a computer-readable storage medium such as the RAM 10b or the ROM 10c and provided or may be provided over a communication network connected by the communication unit 10d. In the information processing apparatus 10, the CPU 10a executes the learning program so as to implement various kinds of operation described with reference to FIG. 2 to be described later. These physical components are exemplary and may not necessarily be discrete. For example, the information processing apparatus 10 may include an LSI (Large-Scale Integration) in which the CPU 10a and the RAM 10b or the ROM 10c are integrated. The information processing apparatus 10 may also include a GPU (Graphical Processing Unit) or an ASIC (Application Specific Integrated Circuit).

Processing Configuration

FIG. 2 is a diagram showing an example of processing blocks of the information processing apparatus 10 according to the embodiment. The information processing apparatus 10 includes an acquiring unit 11, a learning unit 12, an adjusting unit 13, a producing unit 14, a selecting unit 15, an output unit 16, and a storage unit 17. The information processing apparatus 10 may include a general-purpose computer.

The acquiring unit 11 inputs prescribed learning data. For example, the acquiring unit 11 input known training data. For example, an annotated supervisor label may be attached to the training data. In addition, the acquiring unit 11 may input test data corresponding to the training data.

The learning unit 12 performs learning by inputting the acquired prescribed learning data to a learning model 12a using a neural network, the learning model 12a being applied a first function that is produced by weighting each function usable in a hidden layer of the neural network. For example, the learning unit 12 executes learning by the learning model 12a in which at least one of an activation function, a normalization function, a regularization function, a denoising operation function, and a smoothing function of a hidden layer is applied to the first function. Which function is to be used may be appropriately configured with respect to a prescribed problem to be learned or a prescribed data set.

The prescribed problem includes, for example, the problem of performing at least one of classifying, producing, and optimizing at least one of image data, series data, and text data. Here, the image data includes still image data and moving image data. The series data includes audio data and stock price data.

In addition, the prescribed learning model 12a is a learning model including a neural network and, for example, includes at least one of an image recognition model, a series data analysis model, a robot control model, a reinforced learning model, an audio recognition model, an audio production model, an image production model, and a natural language processing model. Furthermore, as a specific example, the prescribed learning model 12a may be any of a CNN (Convolutional Neural Network), an RNN (Recurrent Neural Network), a DNN (Deep Neural Network), an LSTM (Long Short-Term Memory), a bidirectional LSTM, a DQN (Deep Q-Network), a VAE (Variational AutoEncoder), GANs (Generative Adversarial Networks), and a flow-based production model.

In addition, the learning model 12a also includes a model obtained by pruning, quantization, distillation, or transfer of a pre-trained model. Note that these are only examples, and the learning unit 12 may perform machine learning by the learning model for any other problem.

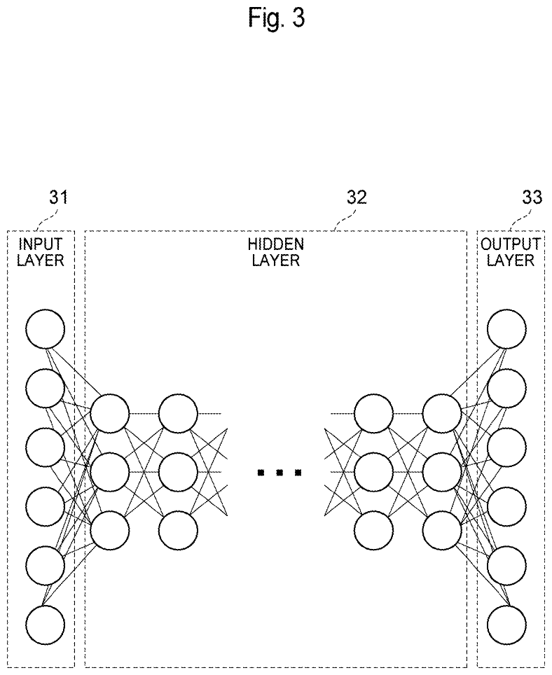

FIG. 3 is a diagram showing an example of the learning model 12a according to the embodiment. In the example shown in FIG. 3, the learning model 12a includes a neural network including an input layer 31, a hidden layer 32, and an output layer 33. The learning unit 12 performs supervised learning using prescribed training data as learning data and produces the learning model 12a in which each weight of the first function has been adjusted. Specifically, the learning unit 12 inputs the training data to the input layer 31 and learns hyper parameters and the like so that an optimal learning result is output from the output layer 33. In this case, every time the hyper parameters are updated (adjusted), the adjusting unit 13 adjusts each weight of the first function to be applied to the hidden layer 32. The first function may be commonly applied to a prescribed node group of the hidden layer 32.

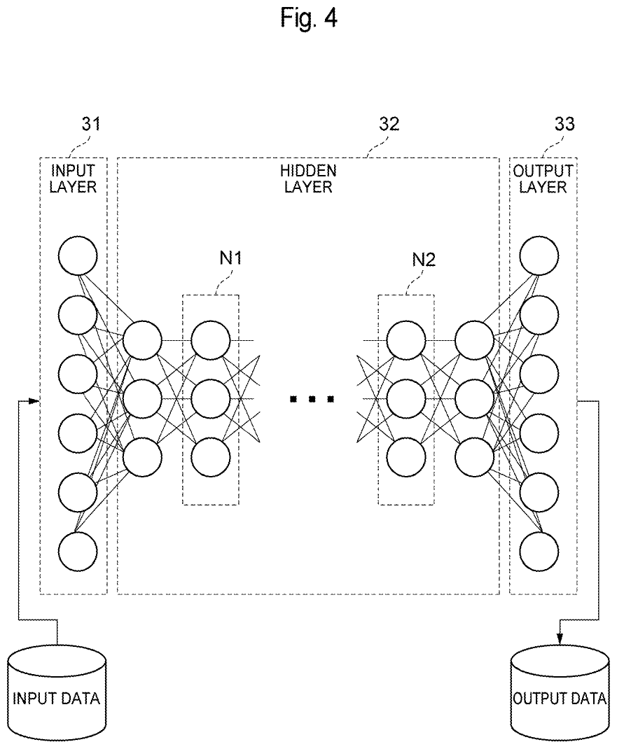

FIG. 4 is a diagram for describing a function to be applied to a hidden layer according to the embodiment. The example shown in FIG. 4 represents a node group N1 to which a prescribed function 1 in the hidden layer 32 is applied and a node group N2 to which a prescribed function 2 in the hidden layer 32 is applied. For example, while an activation function is applied to the prescribed function 1 and a normalization function, a denoising operation function, a regularization function, a smoothing function, or the like is applied to the prescribed function 2, functions are not limited to these examples. In addition, a positional relationship of the hidden layer 32 in the node group N1 and the node group N2 is also an example, and the node groups may be provided at other positions in the hidden layer 32. For example, a suitable function may be respectively applied to a node group in each layer of the hidden layer 32. Accordingly, by more appropriately setting the prescribed function 1 and/or the prescribed function 2 to be applied to the hidden layer 32, learning accuracy of the learning model 12a can be improved.

Returning now to FIG. 2, the adjusting unit 13 adjusts each weight of the first function when a parameter of the neural network is updated using error back propagation based on a supervisor label of the prescribed learning data. For example, when learning the learning model 12a, the learning unit 12 updates a hyper parameter or a bias of the learning model 12a by error back propagation based on a supervisor label of the learning data (training data). In doing so, the adjusting unit 13 performs adjustment by a prescribed method with respect to each weight of the first function. Alternatively, instead of having the learning unit 12 update hyper parameters or the like, the adjusting unit 13 may adjust each weight and each hyper parameter or the like may store each weight that minimizes a loss function.

For example, when adjusting each weight, each weight may be sequentially adjusted from an initial value set in advance. In this case, any adjustment method may be used as long as each weight is adjusted so that a sum of all of the weights equals 1 and each weight is adjusted in a different manner to a previously-performed adjustment. For example, the adjusting unit 13 changes each weight in order in increments of a prescribed value and changes all combinations. For example, the adjusting unit 13 decrements a weight wₖ by a prescribed value from an initial value, increments a weight wₖ₊₁ by the prescribed value from an initial value, and when whichever weight becomes 0 or less or 1 or more, adds 1 to k and repeats changing the weights from their respective initial values. In addition, the condition that the sum of all weights equals 1 need not be provided, in which case an adjustment may be made at the end using a Softmax function or the like so that the sum of all weights equals 1.

As a result of the learning by the learning unit 12 being ended with satisfying a prescribed condition, the producing unit 14 produces a second function in which each adjusted weight is set to the first function. Since each final weight is being set to the first function at a time point of the end of learning, the producing unit 14 may adopt the final first function as the second function. In addition, when each weight that minimizes a loss function is being stored with respect to each hyper parameter, the producing unit 14 may produce the second function by specifying each weight corresponding to a hyper parameter of which the loss function indicates a smallest value.

For example, the first function is a formula obtained by weighting and linearly combining the respective functions. While a formula of the second function shares a same basic structure as the first function, a value subjected to machine learning and adjustment is set as a weight of each function.

According to the processing described above, a more appropriate function can be applied to a hidden layer in a neural network. With respect to a function of the hidden layer which has conventionally been applied based on knowledge empirically obtained by an engineer, producing a new function by compositely using various functions and using a learning model including a hidden layer that is constructed in accordance with data to be handled, learning accuracy can be improved.

When respective existing functions are to be weighted and linearly combined as the first function as in the example described above, assuming a case where an initial value of a weight of an empirically used function is, for example, 1, weight adjustment of each function is performed by the adjusting unit 13 so that learning accuracy improves as compared to this case. Therefore, compared to an empirically used function, it is expected that learning accuracy will improve by using the second function to which an adjusted weight is set.

Activation Function

When an activation function is used as an example of a function of the hidden layer, a plurality of functions used as the first function include functions to be applied as the activation function and the second function includes functions related to the activation function. The second function is a function that is newly produced by, for example, multiplying each activation function by an adjusted weight.

Examples of the activation function include Swish, a Gaussian Error Linear Unit, an Exponential Linear Unit, SmoothReLU, a Bent Identity function, a sigmoid function, a log Sigmoid function, a tanh function, a tanh Shrink function, an ELU function, a SELU function, a CELU function, a softplus function, an ACON function, a Mish function, and a tanh Exp function. These activation functions are smoothed and differentiable functions. In addition, among these activation functions, at least two or more functions are used as the first function.

Other examples of the activation function include a step function, an identity function, a hardShrink function, a Threshold function, a hardSigmoid function, a hard tanh function, a ReLU function, a ReLU6 function, a leaky-ReLU function, a softmax function, a softmin function, a softsign function, and a hardSwish function. These functions are unsmoothed functions containing undifferentiable points. The first function may be produced by selecting an arbitrary activation function from an activation function library including the activation functions described above regardless of being smoothed or not. It should be noted that the activation functions included in the activation function library are not limited to the examples described above and may include functions that can be applied as activation functions.

While expression (1) represents an example of a first function F₁(x) related to an activation function, it should be noted that expression (1) is merely an example.

F₁(x)=W₁A₁+W₂A₂+W₃A₃ . . . +WₙAₙ Expression (1)
Wₙ: weight
Aₙ: activation function

Accordingly, an adaptively changeable function can be defined as an activation function. In addition, applying a second function to which each pre-trained weight has been set so that accuracy increases as compared to a single activation function enables learning accuracy of the neural network to be improved.

Furthermore, the selecting unit 15 may be further provided which selects, when the activation function library is used or, in other words, when an activation function is used for each function of the first function, any of a first group including smoothed activation functions and a second group including arbitrary activation functions. For example, the selecting unit 15 selects the first group or the second group in accordance with an operation by a user and produces the first function using an arbitrary activation function among the selected group. It should be noted that the first group may include the smoothed functions described above and the second group may include all of the functions described above. In other words, the first group and the second group may include overlapping activation functions.

Accordingly, when the first group is selected, an activation function to become means of protection against an adversarial attack can be produced. Hereinafter, the fact that an activation function of the first group becomes a method of protection against an adversarial attack will be described.

An adversarial example (AE) refers to data obtained by adding a perturbation to input data. While an adversarial example normally refers to an image including noise, in reality, an adversarial example is a concept that can be applied to all AI such as a natural language. Here, an example of image recognition will be described as an example in order to facilitate understanding. Although an original image and an AE appear almost identical to the human eye, there is a difference in inference results due to machine learning. Specifically, with an AE, learning accuracy declines and a desirable inference result cannot be obtained.

A countermeasure by an AE against an attack is to learn the AE itself. This is referred to as adversarial training (AT). While there are several types of AT, once an AE becomes correctly identified, conversely, an original image may no longer be correctly identified. In other words, learning accuracy declines in exchange for becoming capable of accommodating a certain amount of variation in data. Generally, there is a tradeoff between robustness and accuracy of a machine learning model and it was thought that a similar tradeoff also applied to AT.

However, a study (hereinafter, also referred to as “present study”) on smooth adversarial training (Cihang Xie, Mingxing Tan, Boqing Gong, Alan Yuille, Quoc V. Le, “Smooth adversarial training,” arXiv: 2006.14536, Jun. 25, 2020) focused on the fact that an AE is produced based on a gradient and that a gradient is a differential of an activation function and concluded that, in order to perform better AT, an activation function should be smooth (smooth adversarial training or SAT).

In addition, while an activation function of oft-used ResNet is ReLU, the present study revealed that non-smoothness of ReLU undermines AT and verified that SAT strengthens AT.

Therefore, using the activation function library of the first group that is a group of differentiable activation functions as the plurality of activation functions used as the first function enables the second function to strengthen adversarial training.

While expression (2) represents an example of a first function F₂(x) that is produced using an activation function included in the first group, it should be noted that expression (2) is merely an example.

F₂(x)=W₁AR₁+W₂AR₂+W₃AR₃ . . . +WₙARₙ Expression (2)
Wₙ: weight
ARₙ: differentiable activation function (smoothing activation function)

Accordingly, an adaptively changeable function can be defined as an activation function. In addition, applying a second function to which each pre-trained weight has been set so that accuracy increases as compared to a single activation function enables learning accuracy of the neural network to be improved while also improving robustness.

Dimensional Compression Function

When a normalization function or a standardization function is used as an example of a function of the hidden layer, a plurality of functions used as the first function include functions to be applied as the normalization function or the standardization function and the second function includes functions related to the normalization function or the standardization function. In this case, a normalization function and a standardization function will be collectively referred to as a dimensional compression function. The second function is a function that is newly produced by, for example, multiplying each dimensional compression function by an adjusted weight.

Examples of the normalization function include batch normalization (BN), principal component analysis (PCA), singular value decomposition (SVD), zero-phase component analysis (ZCA), local response normalization (LRN), global contrast normalization (GCN), and local contrast normalization (LCN).

In addition, examples of the standardization function include a MinMax Scaler, a Standard Scaler, a Robust Scaler, and a Normalizer. The first function may be produced by selecting an arbitrary dimensional compression function from a dimensional compression function library including the dimensional compression functions described above. It should be noted that the dimensional compression functions included in the dimensional compression function library are not limited to the examples described above and may include functions that can be applied as dimensional compression functions. Furthermore, normalization or standardization may be selected as a dimensional compression function in accordance with characteristics of data that is a learning object and the first function may be produced from the selected functions.

While expression (3) represents an example of a first function F₃(x) that is produced using a dimensional compression function, it should be noted that expression (3) is merely an example.

F₃(x)=W₁N₁+W₂N₂+W₃N₃ . . . +WₙNₙ Expression (3)
Wₙ: weight
Nₙ: dimensional compression function

Accordingly, an adaptively changeable function can be defined as a dimensional compression function. In addition, applying a second function to which each pre-trained weight has been set so that accuracy increases as compared to a single dimensional compression function enables differences in scale among respective pieces of input data to be rectified and enables learning accuracy of the neural network to be improved.

Denoising Operation Function

When a function related to a denoising operation is used as an example of a function of the hidden layer, a plurality of functions used as the first function include functions to be applied as the denoising operation function and the second function includes functions related to the denoising operation function. The second function is a function that is newly produced by, for example, multiplying each denoising operation function by an adjusted weight.

Examples of the denoising operation function include a non-local, a GAUSSIAN softmax, Dot Product sets, a Bilateral filter, a Mean filter, and a Median filter. The first function may be produced by selecting an arbitrary denoising operation function from a denoising operation function library including the denoising operation functions described above. It should be noted that the denoising operation functions included in the denoising operation function library are not limited to the examples described above and may include functions that can be applied as denoising operation functions.

While expression (4) represents an example of a first function F₄(x) that is produced using a denoising operation function, it should be noted that expression (4) is merely an example.

F₄(x)=W₁D₁+W₂D₂+W₃D₃ . . . +WₙDₙ Expression (4)
Wₙ: weight
Dₙ: denoising operation function

Accordingly, an adaptively changeable function can be defined as a denoising operation function. In addition, applying a second function to which each pre-trained weight has been set so that accuracy increases as compared to a single denoising operation function enables noise in input data to be appropriately removed and enables learning accuracy of the neural network to be improved.

Smoothing Function

When a function related to smoothing is used as an example of a function of the hidden layer, a plurality of functions used as the first function include functions to be applied as the smoothing function and the second function includes functions related to the smoothing function. The second function is a function that is newly produced by, for example, multiplying each smoothing function by an adjusted weight.

Examples of the smoothing function include a moving-average filter, a Savitzky-Golay filter, Fourier transform, and local regression smoothing (such as LOWESS and LOESS, local regression, and robust local regression). The first function may be produced by selecting an arbitrary smoothing function from a smoothing function library including the smoothing functions described above. It should be noted that the smoothing functions included in the smoothing function library are not limited to the examples described above and may include functions that can be applied as smoothing functions.

While expression (5) represents an example of a first function F₅(x) that is produced using a smoothing function, it should be noted that expression (5) is merely an example.

F₅(x)=W₁S₁+W₂S₂+W₃S₃ . . . +WₙSₙ Expression (5)
Wₙ: weight
Sₙ: smoothing function

Accordingly, an adaptively changeable function can be defined as a smoothing function. In addition, applying a second function to which each pre-trained weight has been set so that accuracy increases as compared to a single smoothing function enables noise to be appropriately removed when, for example, series data is input and enables learning accuracy of the neural network to be improved.

Regularization Function

When a function related to regularization is used as an example of a function of the hidden layer, a plurality of functions used as the first function include functions to be applied as the regularization function and the second function includes functions related to the regularization function. The second function is a function that is newly produced by, for example, multiplying each regularization function by an adjusted weight.

Examples of the regularization function include L1 regularization [Tibshirani, 1996], L2 regularization [Tikhonov, 1943], Weight decay [Hanson and Pratt, 1988], Early Stopping [Morgan and Bourlard, 1990], Dropout [Srivastava et al., 2014], Batch normalization [Ioffe and Szegedy, 2015], Mixup [Zhang et al., 2018], Image augment [Shorten and Khoshgoftaar, 2019], and Flooding [Ishida, 2020]. The first function may be produced by selecting an arbitrary regularization function from a regularization function library including the regularization functions described above. It should be noted that the regularization functions included in the regularization function library are not limited to the examples described above and may include functions that can be applied as regularization functions.

While expression (6) represents an example of a first function F₆(x) that is produced using a regularization function, it should be noted that expression (6) is merely an example.

F₆(x)=W₁L₁+W₂L₂+W₃L₃ . . . +WₙLₙ Expression (6)
Wₙ: weight
Lₙ: regularization function

Accordingly, an adaptively changeable function can be defined as a regularization function. In addition, applying a second function to which each pre-trained weight has been set so that accuracy increases as compared to a single regularization function enables over-learning to be appropriately prevented and enables learning accuracy of the neural network to be improved.

An evaluation of a learning result (an inference result) may be performed using test data with respect to a learning model using the second function having each weight adjusted by the machine learning described above. A first evaluation result (in the case of a classification problem, classification accuracy) by a learning model using an existing function and a second evaluation result by a learning model to which the second function has been applied are compared with each other. The second function may be applied when the second evaluation result is actually higher than the first evaluation result.

This concludes the description of processing by the information processing apparatus 10 in a learning phase. Hereinafter, processing by the information processing apparatus 10 in an inference phase when learning (inference) is to be performed with respect to unknown data using a learning model to which is applied the second function produced in the learning phase will be described.

The acquiring unit 11 acquires prescribed data. For example, the acquiring unit 11 may acquire data stored in the storage unit 17, acquire data received via a network, or acquire data in accordance with a user operation.

The learning unit 12 performs learning by inputting the prescribed data acquired by the acquiring unit 11 to a learning model to which the second function described above is applied. The learning model is a learning model using the first function that is produced by weighting each function usable in a hidden layer of a neural network. As each weight, when a parameter of the neural network is updated using error back propagation, each weight of the first function is adjusted and each adjusted weight is set. In addition, adjusting each weight of the first function when a parameter of the neural network is updated includes generally adjusting each weight of the first function before the parameter of the neural network is updated using error back propagation and once again generally adjusting each weight of the first function after the parameter of the neural network has been updated.

For example, as the first function that is produced by weighting each function usable in a hidden layer of a neural network of the learning model, a second function is applied in which each adjusted weight is set to the first function in a case where a parameter of the neural network is updated using error back propagation and each weight of the first function is adjusted.

As described above, in the inference phase, a learning model is used which is learned in the learning phase and in which the first function (synonymous with the second function) to which each adjusted weight has been set is applied to the hidden layer. In addition, the second function to be applied to the hidden layer need not necessarily require learning in advance and a coefficient or a weight related to a single function (for example, a linearly combined function) obtained by compositely combining a plurality of functions may be appropriately adjusted.

The output unit 16 outputs a result of the learning by the learning unit 12. For example, the output unit 16 outputs an inference result by the learning unit 12 as an output result. Accordingly, inference can be performed using a learning model in which functions in the hidden layer 32 have been made more appropriate and a more appropriate inference result can now be obtained.

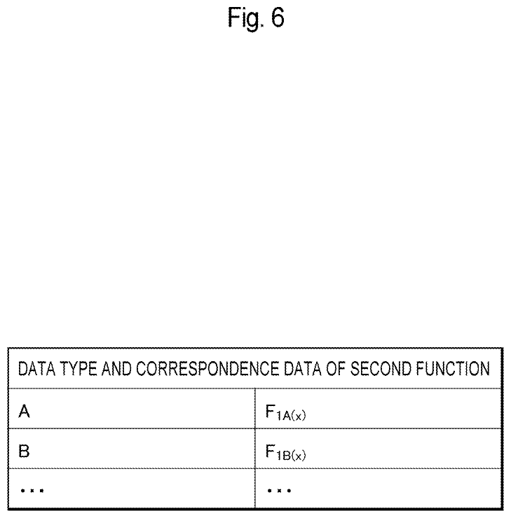

In addition, in the learning phase, an appropriate second function may be respectively obtained in accordance with a type of training data such as a type of data including image data, series data, and text data (for example, characteristics information). Furthermore, the storage unit 17 stores correspondence data (for example, a correspondence table: refer to FIG. 6) in which an appropriate second function has been associated with each data type. In this case, the learning unit 12 may specify a type of prescribed data acquired by the acquiring unit 11 based on characteristics of the data. In addition, the learning unit 12 may extract the second function corresponding to the specified type of data from the storage unit 17 and apply the extracted second function to a prescribed position (for example, a prescribed layer) of the hidden layer 32 of the learning model 12a.

Accordingly, the information processing apparatus 10 can specify an appropriate second function in accordance with a type of data that is an inference object and, by applying the second function to the hidden layer 32, the information processing apparatus 10 can more appropriately make an inference in accordance with the data.

Example of Data

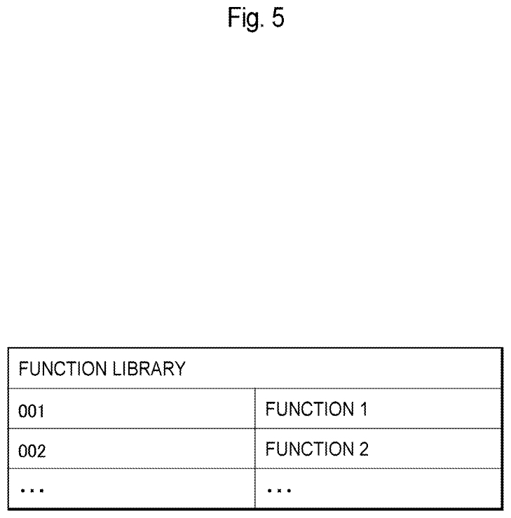

FIG. 5 is a diagram showing an example of a function library according to the embodiment. In the example shown in FIG. 5, a function is associated for each function ID. For example, when the function library is an activation function library, function 1 is Swish, function 2 is a Gaussian Error Linear Unit, or the like. In addition, an ID may be assigned to each function library and, for each function library ID, an activation function library, a dimensional compression function library, a denoising operation function library, a smoothing processing library, a regularization library, and the like may be stored in the storage unit 17.

The learning unit 12 may use the first function having been weighted for all functions stored in the function library or may only use the weighted first function on arbitrary functions saved in the function library.

FIG. 6 is a diagram showing an example of types of data and correspondence data of a second function according to the embodiment. In the example shown in FIG. 6, a second function F_{1A}(x) is associated with a data type A and a second function F_{1B}(x) is associated with a data type B. It should be noted that second functions also include types such as an activation function, a normalization function, a dimensional compression function, a denoising operation function, a regularization function, and a smoothing function. Therefore, for each type of data, a second function related to an activation function, a second function related to a normalization function, a second function related to a dimensional compression function, a second function related to a denoising operation function, a second function related to a regularization function, and a second function related to a smoothing function may be associated. It should be noted that the pieces of data shown in FIGS. 5 and 6 represent examples of function data 17a.

Operation

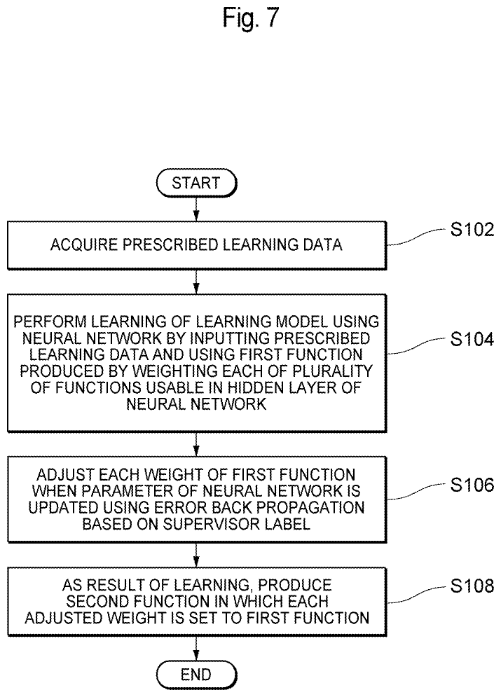

FIG. 7 is a flowchart showing an example of processing in a learning phase according to the embodiment. The processing shown in FIG. 7 is executed by the information processing apparatus 10.

In step S102, the acquiring unit 11 of the information processing apparatus 10 acquires prescribed learning data. As the learning data, training data may be acquired first and test data for evaluation may be input next. In addition, a supervisor label is attached to the learning data. The acquiring unit 11 may acquire prescribed data stored in the storage unit 17, acquire prescribed data having been received via a network, or acquire prescribed data having been input in accordance with a user operation.

In step S104, the learning unit 12 of the information processing apparatus 10 performs learning by inputting the prescribed learning data to a learning model using a neural network, the learning model being applied a first function that is produced by weighting each function usable in a hidden layer of the neural network.

In step S106, the adjusting unit 13 of the information processing apparatus 10 adjusts each weight of the first function when a parameter of the neural network is updated using error back propagation based on a supervisor label of the prescribed learning data.

In step S108, as a result of the learning by the learning unit 12, the producing unit 14 of the information processing apparatus 10 produces a second function in which each adjusted weight is set to the first function. For example, when the learning ends by minimizing a loss function, the producing unit 14 may extract each weight of the first function at that time point.

Accordingly, each weight of the first function is adjusted, and by producing the second function to which each adjusted weight is set, a function to be applied to the hidden layer 32 can be made more appropriate. In addition, an evaluation may be performed by inputting test data to the learning model 12a to which the second function produced with respect to the training data is applied.

For example, when the first function and the second function are related to activation functions, a first evaluation result of test data by a learning model using a single activation function and a second evaluation result of test data by a learning model using the second function are compared with each other. Theoretically, although the second evaluation result is estimated to be better since each weight of the first function is adjusted so that accuracy becomes higher than using a single activation function, the estimate can actually be substantiated using test data. At this point, if the second evaluation result of the test data turns out be worse, a method of adjusting each weight of the first function or an initial value of each weight may be changed and the learning described above may be executed once again using the training data.

Accordingly, by applying the second function stored after being evaluated using test data, reliability of improving learning accuracy can be increased. In addition, the storage unit 17 may store, for each piece of learning data, a type based on characteristics of the learning data and a second function in association with each other.

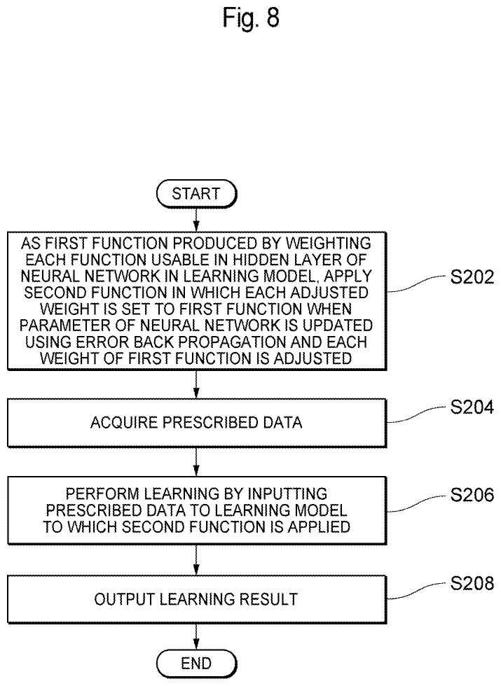

FIG. 8 is a flowchart showing an example of processing in an inference phase according to the embodiment. The processing shown in FIG. 8 is executed by the information processing apparatus 10. In addition, the processing shown in FIG. 8 is in a state where the processing shown in FIG. 7 has been executed and an appropriate second function can be applied.

In step S202, as the first function that is produced by weighting each function usable in a hidden layer of a neural network of the learning model, the learning unit 12 of the information processing apparatus 10 applies a second function in which each adjusted weight is set to the first function in a case where a parameter of the neural network is updated using error back propagation and each weight of the first function is adjusted.

In step S204, the acquiring unit 11 acquires prescribed data.

In step S206, the learning unit 12 performs learning (inference) by inputting the prescribed data to a learning model to which the second function is applied.

In step S208, the output unit 16 outputs a result of the learning (inference) by the learning unit 12.

Accordingly, by using a learning model to which a function more appropriate than using a single function has been applied as a function in a hidden layer of the learning model, accuracy of inference can be improved. It should be noted that step S202 and step S204 may be transposed in the processing shown in FIG. 8, in which case the learning unit 12 may specify a second function corresponding to the acquired type of data and use a learning model to which the specified second function has been applied.

The embodiment described above is intended to facilitate understanding of the present invention and is not intended to restrictively interpret the present invention. The respective elements constituting the embodiment as well as arrangements, materials, conditions, shapes, sizes, and the like of the elements are not limited to those exemplified above and can be modified as deemed appropriate. In addition, configurations respectively described in different embodiments can be partially replaced by or combined with one another. Furthermore, the information processing apparatus 10 in the learning phase and the information processing apparatus 10 in the inference phase may be different computers. In this case, a produced second function may be transmitted via a network.

### APPENDICES

### Appendix 1

An information processing apparatus including a memory and one or a plurality of processors, wherein

the memory stores:

a learning model using a neural network;

each function usable in a hidden layer of the neural network; and

a first function that is produced by weighting each of the functions, and

the one or a plurality of processors:

acquire prescribed learning data;

apply the first function commonly to a prescribed node group in a hidden layer of the learning model;

perform learning by inputting the acquired prescribed learning data to the learning model in which the first function has been applied to the hidden layer;

when learning the learning model, update a parameter of a neural network of the learning model by error back propagation, based on a supervisor label of the prescribed learning data;

adjust each weight of the first function when the parameter of the neural network is updated; and

produce, after the learning model is learned, a second function in which each of the adjusted weights is set to the first function.

### Appendix 2

An information processing apparatus including a memory and one or a plurality of processors, wherein

the memory stores:

a learning model using a neural network;

each function usable in a hidden layer of the neural network; and

a first function that is produced by weighting each of the functions, and

the one or a plurality of processors:

acquire prescribed learning data;

perform learning by inputting the acquired prescribed learning data to the learning model in which the first function has been applied to the hidden layer;

when learning the learning model, update a parameter of a neural network of the learning model by error back propagation based on a supervisor label of the prescribed learning data;

adjust each weight of the first function when a parameter of the neural network is updated;

produce, after the learning model is learned, a second function in which each of the adjusted weights is set to the first function; and

associate the second function and a type of the prescribed learning data with each other and store the same in the memory.

### Appendix 3

The information processing apparatus according to appendix 1 or 2, wherein

the one or a plurality of processors

select, when an activation function is used for each of the functions, any of a first group including smoothed activation functions and a second group including arbitrary activation functions, and

activation functions in a selected group are used as a plurality of functions to be used in the first function.

### Appendix 4

The information processing apparatus according to appendix 1 or 2, wherein

each of the functions is any one of a normalization function, a standardization function, a denoising operation function, a smoothing function, and a regularization function.

### Appendix 5

An information processing method executed by one or a plurality of processors provided in an information processing apparatus including a memory storing a learning model using a neural network, each function usable in a hidden layer of the neural network, and a first function that is produced by weighting each of the functions, the information processing method including:

acquiring prescribed learning data;

applying the first function commonly to a prescribed node group in a hidden layer of the learning model;

performing learning by inputting the acquired prescribed learning data to the learning model in which the first function has been applied to the hidden layer;

when learning the learning model, updating a parameter of a neural network of the learning model by error back propagation, based on a supervisor label of the prescribed learning data;

adjusting each weight of the first function when the parameter of the neural network is updated; and

producing, after the learning model is learned, a second function in which each of the adjusted weights is set to the first function.

### Appendix 6

An information processing method executed by one or a plurality of processors provided in an information processing apparatus including a memory storing a learning model using a neural network, each function usable in a hidden layer of the neural network, and a first function that is produced by weighting each of the functions, the information processing method including:

acquiring prescribed learning data;

performing learning by inputting the acquired prescribed learning data to the learning model in which the first function has been applied to the hidden layer;

when learning the learning model, updating a parameter of a neural network of the learning model by error back propagation based on a supervisor label of the prescribed learning data;

adjusting each weight of the first function when a parameter of the neural network is updated;

producing, after the learning model is learned, a second function in which each of the adjusted weights is set to the first function; and

associating the second function and a type of the prescribed learning data with each other and storing the same in the memory.

### Appendix 7

A non-transitory computer-readable storage medium storing a program which causes one or a plurality of processors provided in an information processing apparatus including a memory storing a learning model using a neural network, each function usable in a hidden layer of the neural network, and a first function that is produced by weighting each of the functions to execute:

acquiring prescribed learning data;

applying the first function commonly to a prescribed node group in a hidden layer of the learning model;

performing learning by inputting the acquired prescribed learning data to the learning model in which the first function has been applied to the hidden layer;

when learning the learning model, updating a parameter of a neural network of the learning model by error back propagation, based on a supervisor label of the prescribed learning data;

adjusting each weight of the first function when the parameter of the neural network is updated; and

producing, after the learning model is learned, a second function in which each of the adjusted weights is set to the first function.

### Appendix 8

A non-transitory computer-readable storage medium storing a program which causes one or a plurality of processors provided in an information processing apparatus including a memory storing a learning model using a neural network, each function usable in a hidden layer of the neural network, and a first function that is produced by weighting each of the functions to execute:

acquiring prescribed learning data;

performing learning by inputting the acquired prescribed learning data to the learning model in which the first function has been applied to the hidden layer;

when learning the learning model, updating a parameter of a neural network of the learning model by error back propagation based on a supervisor label of the prescribed learning data;

adjusting each weight of the first function when the parameter of the neural network is updated;

producing, after the learning model is learned, a second function in which each of the adjusted weights is set to the first function; and

associating the second function and a type of the prescribed learning data with each other and storing the same in the memory.

### Appendix 9

An information processing method executed by one or a plurality of processors provided in an information processing apparatus including a memory storing a learning model using a neural network and a second function in which, after a parameter of the neural network is updated using error back propagation with respect to a first function that is produced by weighting each function usable in a hidden layer of the neural network and each weight of the first function is adjusted, each of the adjusted weights is set to the first function, the information processing method including:

acquiring prescribed data;

performing learning by inputting the prescribed data to the learning model in which the second function is commonly applied to a prescribed node group of the hidden layer; and

outputting a result of the learning.

### Appendix 10

An information processing method executed by one or a plurality of processors provided in an information processing apparatus including a memory storing a learning model using a neural network and a second function in which, after a parameter of the neural network is updated using error back propagation with respect to a first function that is produced by weighting each function usable in a hidden layer of the neural network and each weight of the first function is adjusted, each of the adjusted weights is set to the first function, the information processing method including:

acquiring prescribed data;

specifying a type of the prescribed data, based on characteristics of the prescribed data;

extracting a second function corresponding to the specified type from the memory that stores a second function corresponding to each type of the prescribed data;

performing learning by inputting the prescribed data to the learning model in which the second function is applied to the hidden layer; and

outputting a result of the learning.

### Appendix 11

An information processing apparatus including a memory and one or a plurality of processors, wherein

the memory stores:

a learning model using a neural network; and

a second function in which, after a parameter of the neural network is updated using error back propagation with respect to a first function that is produced by weighting each function usable in a hidden layer of the neural network and each weight of the first function is adjusted, each of the adjusted weights is set to the first function, and

the one or a plurality of processors execute:

acquiring prescribed data;

performing learning by inputting the prescribed data to the learning model in which the second function is commonly applied to a prescribed node group of the hidden layer; and

outputting a result of the learning.

### Appendix 12

An information processing apparatus including a memory and one or a plurality of processors, wherein

the memory stores:

a learning model using a neural network; and

a second function in which, after a parameter of the neural network is updated using error back propagation with respect to a first function that is produced by weighting each function usable in a hidden layer of the neural network and each weight of the first function is adjusted, each of the adjusted weights is set to the first function, and

the one or a plurality of processors execute:

acquiring prescribed data;

specifying a type of the prescribed data, based on characteristics of the prescribed data;

extracting a second function corresponding to the specified type from the memory that stores a second function corresponding to each type of the prescribed data;

performing learning by inputting the prescribed data to the learning model in which the second function is applied to the hidden layer; and

outputting a result of the learning.

### Appendix 13

A non-transitory computer-readable storage medium storing a program which causes one or a plurality of processors provided in an information processing apparatus including a memory storing a learning model using a neural network and a second function in which, after a parameter of the neural network is updated using error back propagation with respect to a first function that is produced by weighting each function usable in a hidden layer of the neural network and each weight of the first function is adjusted, each of the adjusted weights is set to the first function to execute:

acquiring prescribed data;

performing learning by inputting the prescribed data to the learning model in which the second function is commonly applied to a prescribed node group of the hidden layer; and

outputting a result of the learning.

### Appendix 14

A non-transitory computer-readable storage medium storing a program which causes one or a plurality of processors provided in an information processing apparatus including a memory storing a learning model using a neural network and a second function in which, after a parameter of the neural network is updated using error back propagation with respect to a first function that is produced by weighting each function usable in a hidden layer of the neural network and each weight of the first function is adjusted, each of the adjusted weights is set to the first function to execute:

acquiring prescribed data;

specify a type of the prescribed data, based on characteristics of the prescribed data;

extracting a second function corresponding to the specified type from the memory that stores a second function corresponding to each type of the prescribed data;

performing learning by inputting the prescribed data to the learning model in which the second function is applied to the hidden layer; and

output a result of the learning.

### Appendix 15

An information processing apparatus including:

an acquiring unit which acquires prescribed learning data;

a learning unit which performs learning by inputting the prescribed learning data to a learning model using a neural network, the learning model being a learning model in which a first function that is produced by weighting each smoothed activation function usable in a hidden layer of the neural network is applied;

an adjusting unit which adjusts each weight of the first function when a parameter of the neural network is updated using error back propagation, based on a supervisor label of the prescribed learning data; and

a producing unit which produces, as a result of the learning, a second function in which each adjusted weight is set to the first function.

### Appendix 16

An information processing method executed by a processor provided in an information processing apparatus, the method including:

acquiring prescribed learning data;

performing learning by inputting the prescribed learning data to a learning model using a neural network, the learning model being a learning model in which a first function that is produced by weighting each smoothed activation function usable in a hidden layer of the neural network is applied;

adjusting each weight of the first function when a parameter of the neural network is updated using error back propagation, based on a supervisor label of the prescribed learning data; and

producing, as a result of the learning, a second function in which each adjusted weight is set to the first function.

### Appendix 17

A non-transitory computer-readable storage medium storing a program which causes a processor provided in an information processing apparatus to execute:

acquiring prescribed learning data;

performing learning by inputting the prescribed learning data to a learning model using a neural network, the learning model being a learning model in which a first function that is produced by weighting each smoothed activation function usable in a hidden layer of the neural network is applied;

adjusting each weight of the first function when a parameter of the neural network is updated using error back propagation, based on a supervisor label of the prescribed learning data; and

producing, as a result of the learning, a second function in which each adjusted weight is set to the first function.

### Appendix 18

An information processing method executed by a processor provided in an information processing apparatus, the method including:

acquiring prescribed data;

performing learning by inputting the prescribed data to a learning model to which is applied, as a first function that is produced by weighting each smoothed activation function usable in a hidden layer of a neural network of the learning model, a second function in which each adjusted weight is set to the first function in a case where a parameter of the neural network is updated using error back propagation and each weight of the first function is adjusted; and

outputting a result of the learning.

### Appendix 19

An information processing apparatus including a processor, wherein

the processor executes:

acquiring prescribed data;

performing learning by inputting the prescribed data to a learning model to which, is applied, as a first function that is produced by weighting each smoothed activation function usable in a hidden layer of a neural network of the learning model, a second function in which each adjusted weight is set to the first function in a case where a parameter of the neural network is updated using error back propagation and each weight of the first function is adjusted; and

outputting a result of the learning.

### Appendix 20

A non-transitory computer-readable storage medium storing a program which causes a processor provided in an information processing apparatus to execute:

acquiring prescribed data;

performing learning by inputting the prescribed data to a learning model to which is applied, as a first function that is produced by weighting each smoothed activation function usable in a hidden layer of a neural network of the learning model, a second function in which each adjusted weight is set to the first function in a case where a parameter of the neural network is updated using error back propagation and each weight of the first function is adjusted; and

outputting a result of the learning.

### EXPLANATION OF REFERENCE NUMERALS

10 Information processing apparatus
10a CPU
10b RAM
10c ROM
10d Communication unit
10e Input unit
10f Display unit
11 Acquiring unit
12 Learning unit
12a Learning model
13 Adjusting unit
14 Producing unit
15 Selecting unit
16 Output unit
17 Storage unit
17a Function data

What is claimed is:

1. An information processing apparatus comprising a memory and one or a plurality of processors, wherein
the memory stores:
a learning model using a neural network;
each function usable in a hidden layer of the neural network; and
a first function that is produced by weighting each of the functions, and
the one or a plurality of processors configured to:
acquire prescribed learning data;
apply the first function commonly to a prescribed node group in a hidden layer of the learning model;
perform learning by inputting the acquired prescribed learning data to the learning model in which the first function has been applied to the hidden layer;
when learning the learning model, update a parameter of a neural network of the learning model by error back propagation, based on a supervisor label of the prescribed learning data;
adjust each weight of the first function when the parameter of the neural network is updated; and
produce, after the learning model is learned, a second function in which each of the adjusted weights is set to the first function.

2. The information processing apparatus according to claim 1, wherein
the one or a plurality of processors configured to
select, when an activation function is used for each of the functions, any of a first group including smoothed activation functions and a second group including arbitrary activation functions, and
activation functions in the selected group are used as a plurality of functions to be used in the first function.

3. The information processing apparatus according to claim 1, wherein
each of the functions is any one of a normalization function, a standardization function, a denoising operation function, a smoothing function, and a regularization function.

4. The information processing apparatus according to any one of claims 1 to 3, wherein
the one or a plurality of processors configured to
associate the second function and a type of the prescribed learning data with each other and store the same in the memory.

5. An information processing method executed by one or a plurality of processors provided in an information processing apparatus including a memory storing a learning model using a neural network, each function usable in a hidden layer of the neural network, and a first function that is produced by weighting each of the functions, the information processing method comprising:
acquiring prescribed learning data;
applying the first function commonly to a prescribed node group in a hidden layer of the learning model;
performing learning by inputting the acquired prescribed learning data to the learning model in which the first function has been applied to the hidden layer;
when learning the learning model, updating a parameter of a neural network of the learning model by error back propagation, based on a supervisor label of the prescribed learning data;
adjusting each weight of the first function when the parameter of the neural network is updated; and
producing, after the learning model is learned, a second function in which each of the adjusted weights is set to the first function.

6. A non-transitory computer-readable storage medium storing a program which causes one or a plurality of processors provided in an information processing apparatus including a memory storing a learning model using a neural network, each function usable in a hidden layer of the neural network, and a first function that is produced by weighting each of the functions to execute:
acquiring prescribed learning data;
apply the first function commonly to a prescribed node group in a hidden layer of the learning model;
performing learning by inputting the acquired prescribed learning data to the learning model in which the first function has been applied to the hidden layer;
when learning the learning model, updating a parameter of a neural network of the learning model by error back propagation, based on a supervisor label of the prescribed learning data;
adjusting each weight of the first function when the parameter of the neural network is updated; and
producing, after the learning model is learned, a second function in which each of the adjusted weights is set to the first function.
